(19) United States
(12) Patent Application Publication
(10) Pub. No.: US 2017/0178242 A1
(43) Pub. Date: Jun. 22, 2017

(54) Method and system for supplementing insureance coverage

(71) Applicant: Glen Joseph Reaux, Houston, TX (US)

(72) Inventor: Glen Joseph Reaux, Houston, TX (US)

(21) Appl. No.: 15/330,941

(22) Filed: Mar. 5, 2014

(51) Int. Cl. G06Q 40/08

(52) U.S. Cl. CPC G06Q 40/08

(57) ABSTRACT

A system involving an insurance product and a plurality of constituents, including an insurance provider, a financial institution or other entity for issuing credit or debit cards, and a plurality of participating vendors. Vendors apply a predetermined percentage of transactions with members (insured; cardholders) to a holding account, in addition to paying a participation fee to the practitioner of the invention. The set aside amounts are used by members to be applied against expenses not otherwise covered under conventional insurance policies (e.g. co-pays and deductibles).

### RELATED APPLICATION DATA

This application is based on and claims the priority of provisional U.S. Patent Application Ser. No. 61/851,304 filed on March 4, 2013, which application being hereby incorporated by reference herein in its entirety.

### FIELD OF THE INVENTION

The present invention relates generally to the insurance industry, and more particularly relates to an insurance product/arrangement involving customers, financial institutions, insurance companies, and third-party member vendors.

### BACKGROUND OF THE INVENTION

Over the next few years, the impact of health reform will have a remarkable impact on the health insurance industry and our American society. Because of the Affordable Care Act (“ACA”), the foreseeable landscape will be in turmoil. Insurance companies, employers, state governments and individual citizens have to look at health insurance in a new light. This will force all parties to make hard decisions. New problems have been created and everyone is looking for innovative and attractive solutions.

Deadlines have been imposed by the Affordable Care Act that must be met by Jan. 1, 2014. The ACA has dramatically changed the healthcare landscape and will continue to do so. Turmoil in the market will increase as states' governments are forced to establish insurance pools, employers are forced to make human resources decisions, individuals are forced to get coverage and insurance companies have to develop products that not only are in compliance with the ACA but must be profitable and maintain a high rate of retention.

Market turmoil will be devastating for companies unable to make proper adjustments to the ever changing dynamics that they will be forced to deal with. All types of policies are now being thrown into flux. Medicare, Medicaid, Employer Sponsored Insurance (ESI), Small Business Health Options Programs (SHOP), Individual plans and newly state and federally subsidized alternatives will all be impacted. According to the Deloitte Touche Model, “The Impact of Health Reform on Health Insurance Coverage: Projection Scenarios Over 10 Years,” the individual health insurance market may increase from about 14 million purchasers in 2009 to a range of 25.7 to 72.7 million purchasers in 2020 as a result of ACA. That is more than a 500% increase over the next seven years.

Currently, so-called “affinity” marketing programs have proven to be an indispensable component of our national economy. For example, the American Association of Retired Persons (AARP) has an ongoing marketing program with United Healthcare. Kroger, a major grocery retailer in the southern United States, has a strong program with Royal Dutch Shell. Across the board, retailers are offering senior citizen discount programs. However, the fact remains that no one has modified this time-tested concept to help reduce the cost of healthcare and supplement the programs that are currently available to persons requiring healthcare.

### SUMMARY OF THE INVENTION

In view of the foregoing and other considerations, the present invention is directed to a system involving an insurance product/arrangement designed to capture and retain a large portion of the expanding $884 billion health insurance market now being enlarged by the passage of the Affordable Care Act (“ACA”). Although the product targets Medicare and Medicaid recipients and others who would become eligible for government assisted healthcare due to the ACA, it is believed that the product is affordable and beneficial to all healthcare insurance recipients.

For the insured, the invention contemplates a superior product to other products currently in practice. To the insurance providers it is complimentary or supplementary to current products and expands profit margins dramatically for both current and future policy members. This makes the invention a more generalized healthcare insurance product. Despite the fact that it is a newly invented insurance product, the invention (referred to herein as the Affinity

Insurance Product or AIP), is highly specialized, and will be the key factor in garnering market share and developing never before seen rates of member retention.

The AIP dramatically increases profits for the insurance companies that are targeted for co-branded and private label products. The product is intended to involve licensing to targeted insurance companies, whereby licensing fees are the primary source of revenues.

The product is a new invention inasmuch as it contemplates a novel relationship between particular participants in a way which provides benefits to all involved that could not be otherwise realized. The invention reduces the healthcare cost for the insured and provides new low cost, high profit centers for the insurance companies. It reduces and in many cases eliminates co-pays and deductibles for expensive procedures. For the median income family, the invention provides thousands of dollars to pay for these expenses, and at no additional cost to the insured. The inventive product, instead of increasing costs to the insurance provider, actually provides an increase in revenues of more than four billion dollars and profits of more than three hundred and twenty million dollars annually from its current customer base.

The inventive product is intended to accomplish several objectives:
1. Reduce the cost of healthcare to the consumer by eliminating co-pays
2. Reduce and possibly eliminate deductibles for medical procedures and hospital stays
3. Provide a consumer healthcare planning tool
4. Add value and increase profit to an insurance companies existing customer base
5. Expand market share and increase retention rate to 90% or greater
6. Develop new revenue streams and profit centers
7. Minimize risk and maximize profit potential for our investors

Basically the inventive product is designed to be offered somewhat like a rider to an existing policy. In accordance with one aspect, the invention may be a complimentary supplement to existing products, or it can be marketed as a stand-alone product. An insurance company's existing customer base becomes its immediate market. In accordance with an important aspect of the invention, when introduced into this market, both customers and insurance companies will receive added values. The companies will dramatically increase their cash flow and profit margins.

### The Product:

1. Insurance company customers who use co-branded debit or credit cards or both for everyday purchases receive rebates or rewards on all purchases from vendors within a network of retailers established by a practitioner of the invention. These rebates or rewards are then applied to the customer's co-pay and deductible savings account linked to their health insurance policy.
2. When presenting to a healthcare institution or physician the account balance is applied to the required co-pay/deductible payment.
3. Cardholders can go online to check their monthly savings balances.
4. When desired, cardholders can plan medical procedures based upon LiveWell account balances.
5. Basically, the cardholder doesn't have to change the way that anything is done in his or her current lifestyle.
6. Cards can be issued to the entire family, all tied to one account , maximizing the potential savings.
7. In the event of death a beneficiary can collect any remaining balance.

According to the US Department of Labor a median income family earns $49,638.00 annually. Their basic monthly expenses average about $1,077.11. When 10% of this money is applied to a system in accordance with the present invention, this amounts to $107.71 monthly or $1,285.32 annually.

### BRIEF DESCRIPTION OF THE DRAWINGS

The present invention is best understood with reference to the following detailed description of embodiments of the invention when read in conjunction with the attached drawings, in which like numerals refer to like elements, and in which:

FIG. 1 is a block diagram illustrating the constituents of an insurance product scheme in accordance with one embodiment of the invention; and

FIG. 2 is a block diagram illustrating the constituents of an insurance product scheme in accordance with another embodiment of the invention.

### DETAILED DESCRIPTION OF A PREFERRED EMBODIMENT OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system, regulatory, and technical constraints), which will vary from one implementation to another. Moreover, attention will necessarily be paid to proper engineering practices for the environment in question. It will be appreciated that such development efforts might be complex and time-consuming, outside the knowledge base of typical laymen, but would nevertheless be a routine undertaking for those of ordinary skill in the relevant fields.

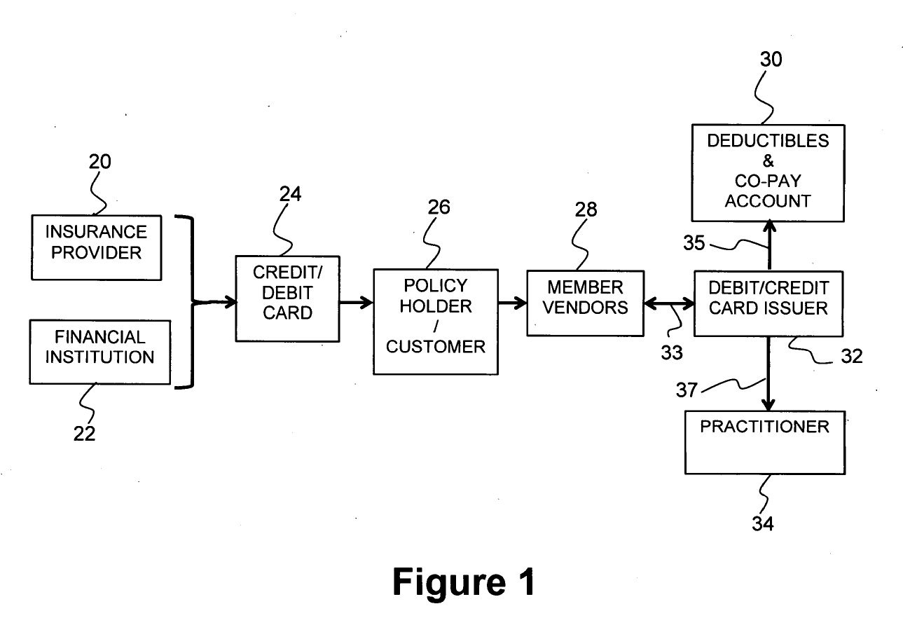

Referring to FIG. 1, there is shown a block diagram illustrating an infrastructure upon which the present invention may be based. As shown in FIG. 1, the system involves several constituents, including an insurance carrier/provider 20, a financial institution 22, a policy member/customer 26, and a plurality of (at least one) member vendors 28. The entity organizing all of the constituents is referred to herein as the practitioner of the invention, represented by block 34 in FIG. 1.

With continued reference to FIG. 1, in an illustrative embodiment of the invention, the insurance carrier 20 and a financial institution 22 collaborate to issue a credit or debit card, represented by block 24 in FIG. 1. Such co-branding relationships between financial institutions and other parties are well known. The credit or debit card is issued to a policy member, who pays an annual “membership” or cardholder's fee to the issuer of the card, as is customary in the industry.

In practice, the policy members/customers 26 use the debit or credit cards 24 to make purchases from member vendors 28. In the disclosed embodiment, the practitioner 34 ensures that a relationship is formed between a plurality of member vendors 28 and the issuer of the debit/credit cards 24, as will be hereinafter described in further detail.

Each time a transaction is conducted with a member vendor 28, payment is made via the credit card issuer, as represented by block 32 and connection (arrow) 33, which is intended to reflect the pre-arranged relationship between the member vendors 28 and the card issuers 32. Those of ordinary skill having the benefit of the present disclosure will appreciate that the credit/debit card issuer may be a financial institution alone, or a financial institution along with a credit card company (e.g., Visa, MasterCard, Discover, etc.) acting as a transaction services provider, also possibly co-branded with a third party insurance company (not represented in FIG. 1).

In accordance with one aspect of the invention, each time a transaction is conducted between the policy member/customer 26 and a member vendor 28, the debit/credit card issuer 32 makes a payment into a deductibles/co-pay account 30, as represented by connection 35 in FIG. 1. This payment may be, for example, 5% to 15% of the transaction amount, and the money is essentially held in escrow on behalf of he customer 26. In accordance with a notable aspect of the invention, the money held in the account 30 can be drawn upon by the customer 26 to cover future deductible and co-pay amounts for health services that normally would be borne as out-of-pocket expenses of the end user 26. As such, the present invention is supplemental to the insured's normal insurance coverage. With continued reference to FIG. 1, a connection 37 reflects the fact that a payment is made from the credit card issuer 32 to the practitioner 34 which establishes the underlying system in accordance with the present invention. This payment 37 may be, for example, 1% or 1.5% of the transaction amount. Connection 33 in FIG. 1 is bi-directional, reflecting the obvious fact that the credit card issuers 32 will be paying the individual member vendors for the goods or services provided, as is customary.

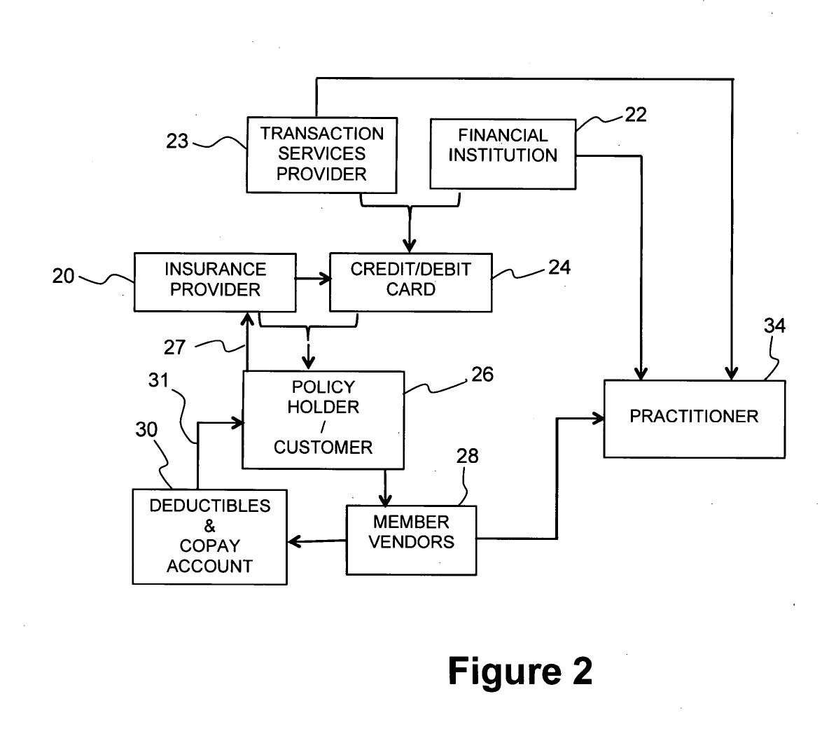

Turning to FIG. 2, there is shown a block diagram illustrating the functionality and infrastructure of a system in accordance with another embodiment of the invention, wherein the same constituents of FIG. 1 have retained identical reference numerals in FIG. 2.

As shown in FIG. 2, the system in accordance with the invention involves an insurance provider 20, a financial institution 22, a plurality of member vendors 28, and a policy holder/customer 26. A transaction services provider 23 is also shown in FIG. 2, reflecting the fact that financial institutions 22 are known to partner with such service providers 23 to issue credit or debit cards 24, as reflected by link 25 in FIG. 2. The credit/debit card 24 may further be offered (i.e., co-branded) by the insurance provider 20.

In accordance with one aspect of the invention, the customer 26 is obliged to pay a “membership” fee to the insurance provider for the privilege of doing business with member vendors 28. Payment of this membership fee is reflected by arrow 27 in FIG. 2. This fee, which might be, for example, $0.25 per month, is in addition to the monthly or annual fees that are paid to the issuer of the debit/credit card 24, which issuer may be the financial institution 22, the transaction services provider 23, and/or the insurance provider 20 or some combination thereof.

Preferably, the insurance provider 20 is responsible for paying a one-time start-up fee (not symbolically represented in FIG. 20) to the practitioner.

As in the previous embodiment, the policy holder/customer 26 uses the debit or credit card 24 to make purchases from member vendors 28 in a customary fashion. For each transaction, the member vendors 28 pay a predetermined amount into a deductibles/co-pay account 30 for the benefit of the customer 26. This payment may be a predetermined percentage (e.g., 10-15%) of the transaction amount. These payments 30 are essentially held in escrow until needed by the user, who can draw upon the amounts accrued in account 30 as necessary to cover deductibles and co-pay amounts for subsequent medical expenses. This is represented by arrow 31 in FIG. 2.
1. Insurance companies 20 will provide the customer base and products that the invention will coexist with.
2. A financial transactions institution 23 will be at the heart of the process. Throughout' this disclosure, MasterCard will be used as an example, although those of ordinary skill in the art will appreciate that the invention is by no means limited to this entity. MasterCard may also serve as a debit card provider.
3. Banks (financial institutions) 22 will be needed to provide credit and debit cards and possibly an escrow account for customers.
4. The practitioner 34 of the present invention will develop and maintain the retail vendor network of marketing partners including all member vendors 28, transaction service providers 23, financial institutions 22, and so on.

Revenue generation for our projections is based upon using the basic family expenditures as the source. Revenue projections are based upon the following formula.

Monthly Contribution×3 Million Members×12=Annual Revenue

Average Monthly Contributions: $44.21

Policy Members (3 million=1.23% of market (9.375% of post-ACA market): $3,000,000.00

Total Monthly Contributions: $132,618,000.00

Annual Contributions: $1,591,416,000.00

Annual Spending w/Vendors: $15,914,160,000.00

This is a new revenue stream never before available to the insurance companies. These monies are to be used for the purpose of paying claims as members draw down on their accounts. There is also benefit for the insurance companies. If these funds were placed in some form of savings account that pays 3% per annum, the earnings from savings alone would be in excess of $47 million. The invention thus offers new revenue streams and new profit centers by tapping into the day-to-day consumer spending of its members. The invention only taps into the basic necessary spending of the median income family. It does not account for additional revenues generated from the disposable income of the family or increased monies added to the equation from upper middle class or wealthy families. However, there are more profit centers for the insurance companies that are created from our product.

The retail vendor network in accordance with the present invention is established by the practitioner 34 and is a low cost value added revenue generation vehicle for the partners involved. These partners are the financial transactions institutions 22, member vendors (retailers) 28, and debit/credit card transaction service providers. A practitioner 34 of the invention is bringing a minimum of three million customers to their businesses. Annually, consumers may be projected to spend $15.6 billion dollars with the retailers in the network.

These customers will provide repeat business for as long as they are members. It is this type of loyal customer base that causes a business to grow. It is this type of customer that provides tangible data that justifies vendor and network partner participation/advertising fees.
1. The interest earned from the invention's rebate account is self-explanatory
2. RETAILERS—Participating membervendors 28 are not charged any form of an up-front start up fee. They are charged their rebate contribution per transaction. The contribution can be from 5% to 10% or more. In addition to their normal transaction service provider or credit provider transaction fee, the retailer pays an additional (e.g. 1.5%) advertising/participation fee to the practitioner of the invention per transaction. In an exemplary embodiment, this money is automatically dispersed by the transaction services provider 23 to four separate bank accounts, as follows:
   (i) 10% (for example) Practitioner Rebate Account $1.6 billion (owned and managed by the insurance provider 20)
   (ii) 0.25% (for example) Insurance Company profit account $39,785,400
   (iii) 1% (for example) Practitioner Insurance Products Inc. Profit Center Account
   (iv) Vendor Transaction Profit Center Account
3. transaction services provider 23 will pay an amount (for example ⅛ of 1% point) as a vendor participation transaction fee which will be divided equally between the practitioner 34 and the insurance provider 20 into their respective profit accounts.
4. Credit card banks 22 wishing to provide the practitioner 34 a co-branded credit card will pay an annual fee per card issued. This fee may be, for example, a minimum of $10.00 per card. Projections suggest that 1 million credit cards may be issued to the 3 million members However, it is a standard practice for banks to charge as much as $25-$75 annually. Logic dictates that a larger fee is negotiable.

At least one embodiment of the invention has been described herein solely for the purposes of illustrating the invention in its various aspects. It is contemplated and to be explicitly understood that various substitutions, alterations, and/or modifications, including but not limited to any such implementation variants and options as may have been specifically noted or suggested herein, including inclusion of technological enhancements to any particular method step or system component discovered or developed subsequent to the date of this disclosure, may be made to the disclosed embodiments of the invention without necessarily departing from the technical and legal scope of the invention as defined in the following claims.

What is claimed is:

1. A method of supplementing the insurance of an insured, comprising:
(a) charging an insurer entity a one-time start-up fee and a monthly maintenance fee for each of a plurality of participating insured members;
(b) charging a financial institution a one-time start-up fee and an annual renewal fee for each credit/debit card issued to participating members;
(c) requiring participating vendor entities to deposit a predetermined portion of each retail transaction with a participating member into an escrow account on behalf of said participating member;
(d) charging said vendor entity a predetermined fee. for each retail transaction with a participating member;
(e) charging said financial institution a predetermined fee for each retail transaction with a participating member.

2. A method in accordance with claim 1, wherein said deposits to said escrow account are applied toward participating members' medical expenses not covered by said insurer entity.

3. A system for supplementing insurance coverage of a plurality of customers, comprising:
a network of member vendors to be patronized by said plurality of customers;
at least one insurance provider;
at least one financial institution for issuing debit or credit cards to said customers;
wherein each of said member vendors contributes a predetermined amount to a deductibles/co-pay account on behalf of customers transacting with said member vendors.
